(19) United States
(12) Patent Application Publication
(10) Pub. No.: US 2009/0157859 A1
(43) Pub. Date: Jun. 18, 2009

(54) Methods And Systems For Accessing A Resource Based On URN Scheme Modifiers

(76) Inventor: Robert P. Morris, Raleigh, NC (US)

Correspondence Address: SCENERA RESEARCH, LLC, 111 CORNING RD., SUITE 220, CARY, NC, 27518, US

(21) Appl. No.: 11/957,809

(22) Filed: Dec. 17, 2007

(51) Int. Cl. G06F 15/173

(52) U.S. Cl. 709/223

(57) ABSTRACT

Methods, systems and computer program products are described for accessing a resource identified in a URN based on URN scheme modifiers. In one aspect, a URI is received having a format that includes a URN scheme identifier for identifying a URN scheme, a scheme-dependent part for identifying a resource, and a URN scheme modifier. The URN scheme modifier includes information for determining a URL for accessing the identified resource. The URN scheme modifier is detected in the received URI, and based on the detected URN scheme modifier, the URL for accessing the resource is determined. Methods, systems and computer program products are described for providing a resource including a URI configured for accessing another resource. A generated first resource includes a determined URI formatted to include a URN scheme modifier including a resolving URL for determining a URL for accessing a second resource.

### BACKGROUND

A uniform resource identifier (URI) is a compact string of characters used to identify or name a resource. The main purpose of this identification is to enable interaction with representations of the resource over a network, typically the World Wide Web, using specific protocols. A URI can be classified as a locator, a name, or both. URIs and their subsets, uniform resource locaters (URLs) and uniform resource names (URNs), have been invaluable in the growth of the web.

A URL is a URI that, in addition to identifying a resource, provides a means of acting upon or obtaining a representation of the resource by describing its primary access mechanism or network “location”. A URN is a URI that can be used to identify a resource without implying its location or how to reference it. For example, the URN “ISBN:0-395-36341-1” is a URI that, like an international standard book number (ISBN), allows one to identify a book, but does not suggest where and how to obtain an actual copy of it.

URIs are defined in schemes defining a specific syntax and can identify associated protocols. A URI scheme is the top level of the URI naming structure. Conventional URIs are formed with a “scheme name” portion followed by a colon character, and the remainder of the URI, which is called the “hierarchical part” in the current Internet Standard STD 66 and the Internet engineering task force (IETF) RFC 3986. The syntax and semantics of the hierarchical part are left largely to the specifications governing individual schemes, subject to certain constraints.

The basic syntax for a URI is:

<scheme>:<hierarchical-part>

This basic syntax of the “hierarchical part” is quite flexible, allowing for information related to naming authority, address information, relative path, parameter, and query information. For example, a syntax that further details the hierarchical part can be:

<scheme>://<authority><path>?<query>

In contrast, the “scheme” portion is static, simply identifying a class of identifiers.

As indicated above, URNs and URLs are subsets of URIs. Both are alike in that both include information that can be used to identify a particular resource, e.g., a web page. While URLs also include information that can be used to access a representation of the resource, URNs do not include such location information. Thus, URNs cannot, by themselves, be used to access the resource.

Accordingly, there exists a need for methods, systems, and computer program products for accessing a resource identified in a URN.

### SUMMARY

Methods, systems and computer program products are described for accessing a resource identified in a URN based on URN scheme modifiers. In one aspect, a URI is received having a format that includes a URN scheme identifier for identifying a URN scheme, a scheme-dependent part for identifying a resource, and a URN scheme modifier. The URN scheme modifier includes information for determining a URL for accessing the identified resource. The URN scheme modifier is detected in the received URI, and based on the detected URN scheme modifier, the URL for accessing the resource is determined.

In another aspect, a system for accessing a resource identified in a URN based on URN scheme modifiers includes a URI handler component configured for receiving a URI formatted to include a URN scheme identifier for identifying a URN scheme, a scheme-dependent part for identifying a resource, and a URN scheme modifier for determining a URL for accessing the identified resource, a URI parser component configured for detecting the URN scheme modifier in the received URI, and a resolver library component configured for determining, based on the detected URN scheme modifier, the URL for accessing the resource.

In another aspect, a system for accessing a resource identified in a URN based on URN scheme modifiers includes means for receiving a URI formatted to include a URN scheme identifier for identifying a URN scheme, a scheme-dependent part for identifying a resource, and a URN scheme modifier for determining a URL for accessing the identified resource, means for detecting the URN scheme modifier in the received URI, and means for determining, based on the detected URN scheme modifier, the URL for accessing the resource.

In another aspect, a computer readable medium embodying a computer program, executable by a machine, for accessing a resource based on URN scheme modifiers includes executable instructions for receiving a URI formatted to include a URN scheme identifier for identifying a URN scheme, a scheme-dependent part for identifying a resource, and a URN scheme modifier for determining a URL for accessing the identified resource, for detecting the URN scheme modifier in the received URI, and for determining, based on the detected URN scheme modifier, the URL for accessing the resource.

In another aspect, a method for providing a resource including a URN configured for accessing another resource is described. Resource information for generating a first resource is received and a URL for determining the URL of a second resource is determined. The first resource is then generated based on the received resource information. Included in the first resource is a URI formatted to include a URN scheme modifier, a scheme-dependent part that identifies the second resource, and a URN scheme modifier for determining a URL for accessing the second resource. The first resource is provided to an executable program for enabling the executable program to provide for accessing the second resource based on the URN scheme modified of the URI included in the first resource.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a flow diagram illustrating a method for accessing a resource identified in a URN based on URN scheme modifiers according to an embodiment;

FIG. 2 is a block diagram illustrating a system for accessing a resource identified in a URN based on URN scheme modifiers according to another embodiment;

FIG. 3 is a block diagram illustrating a system for accessing a resource identified in a URN based on URN scheme modifiers according to another embodiment;

FIG. 4 is a block diagram illustrating a system for accessing a resource identified in a URN based on URN scheme modifiers according to another embodiment;

FIG. 5 is a flow diagram illustrating a method for providing a resource including a URN configured for accessing another resource according to an embodiment;

FIG. 6 is a block diagram illustrating a system for providing a resource including a URN configured for accessing another resource according to another embodiment; and

FIG. 7 is a block diagram illustrating a system for providing a resource including a URN configured for accessing another resource according to another embodiment.

### DETAILED DESCRIPTION

A URI can generally be defined as consisting of four parts, as follows:

<scheme name>: <hierarchical part>[?<query>] [#<fragment>]

The scheme name consists of a letter followed by any combination of letters, digits, and the plus (“+”), period (“.”), or hyphen (“-”) characters; and is terminated by a colon (“:”). The hierarchical part of the URI is intended to hold identification information hierarchical in nature. Usually this part begins with a double forward slash (“//”), followed by an authority part and an optional path. The authority part holds an optional user information part terminated with “@” (e.g. username:password@), a hostname (i.e. domain name or IP address), and an optional port number preceded by a colon “:”. The path part is a sequence of segments (conceptually similar to directories, though not necessarily representing them) separated by a forward slash (“/”). Each segment can contain parameters separated from it using a semicolon (“;”), though this is rarely used in practice.

The query is an optional part separated with a question mark, which contains additional identification information, which is not hierarchical in nature. Its syntax is not generically defined, but is commonly organized as a sequence of <key>=<value> pairs separated by an ampersand, e.g., key1=value1&key2=value2&key3=value3. The fragment is an optional part separated from the front parts by a hash (“#”). It holds additional identifying information, which allows indirect identification of a secondary resource, e.g., a section heading in an article identified by the remainder of the URI.

An example HTTP URI is shown below:

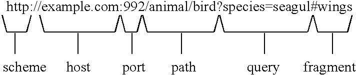

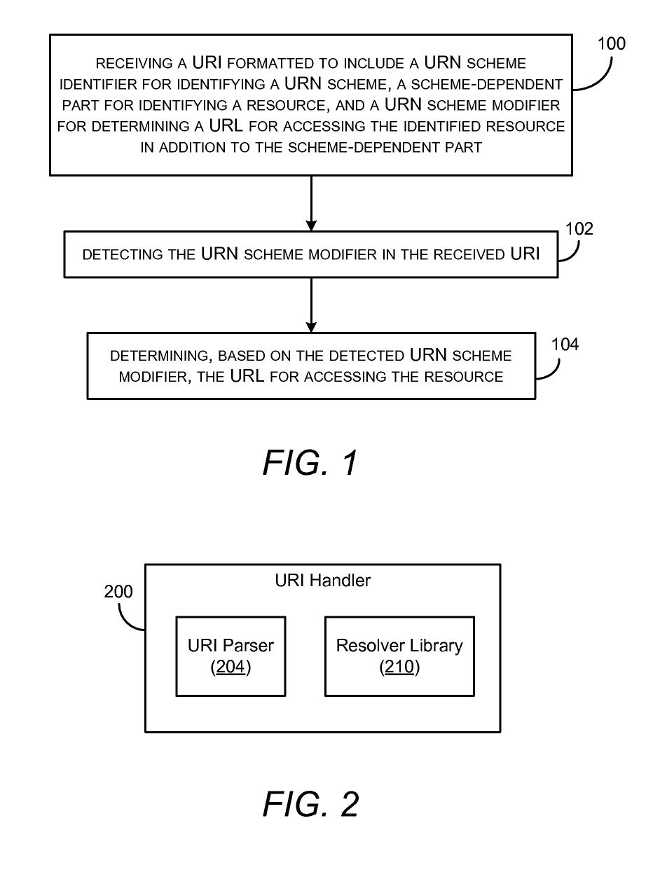

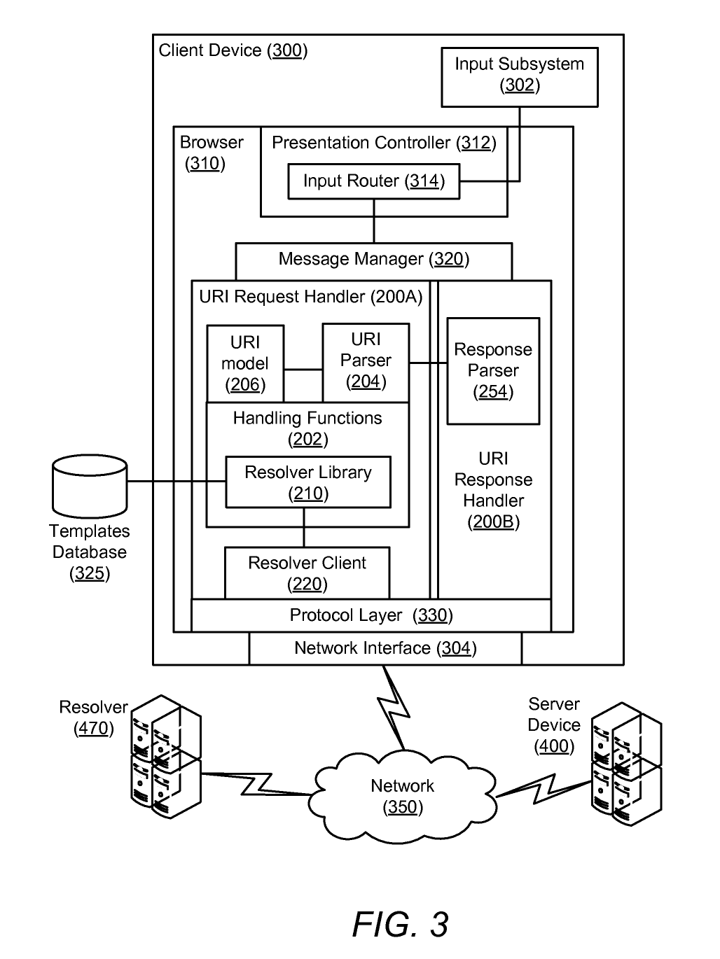

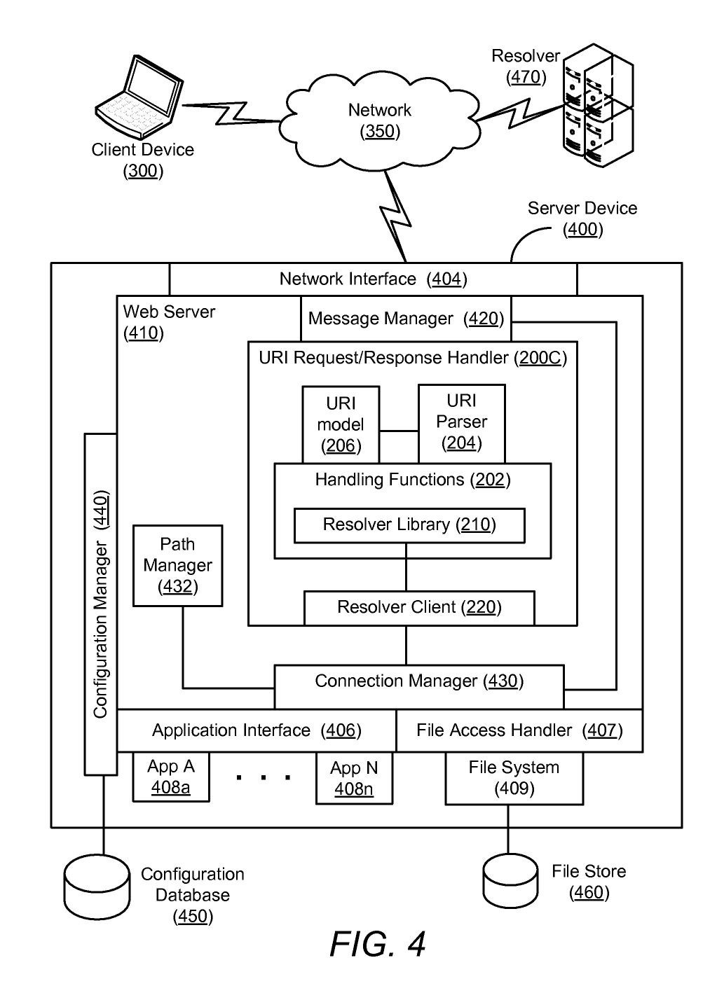

FIG. 1 is a flow diagram illustrating a method for accessing a resource identified in a URN based on URN scheme modifiers according to an exemplary embodiment. FIGS. 2, 3 and 4 are block diagrams illustrating systems for accessing a resource identified in a URN based on URN scheme modifiers according to embodiments of the subject matter described herein. In particular, FIG. 2 illustrates a URI handler component that is configured for accessing a resource identified in a URN based on URN scheme modifiers, while FIG. 3 and FIG. 4 illustrate, respectively, a client-based system and a server-based system for accessing a resource identified in a URN based on URN scheme modifiers. The method illustrated in FIG. 1 can be carried out by, for example, each of the exemplary systems illustrated in FIGS. 2, 3 and 4.

Illustrated in FIG. 2 is a URI handler component 200 that is configured to operate within an execution environment of a device. The URI handler component 200 can operate within a wide range of execution environments and devices. For example, the URI handler component 200 can operate in an execution environment including hardware, such as a processor, for processing instructions included in the URI handler component 200, a processor memory for storing at least a portion of the URI handler component 200 allowing the processor to access instructions and data included in the system.

Illustrated in FIG. 3 is a client device 300 that includes a browser 310 operating within an execution environment (not shown) of the client device 300. The client device 300 can communicate with a web server device 400 via a network 350, which may be, for example, a direct link, a local area network (LAN), an intranet, a wide area network (WAN) such as the Internet, and the like, or any combination thereof. Browsers typically receive and process URIs provided by users via a location bar, for example, and URIs included in links in web content. Thus, a browser 310 is one example of a URI processing application. Any application or service that processes URIs may be modified or configured to support the subject matter described herein.

Illustrated in FIG. 4 is a web server device 400 that includes a web server 410 operating within an execution environment (not shown) of the web server device 400. The web server 410 is enabled to receive messages and send associated responses either on its own or in conjunction with one or more web applications 408a-408n, collectively referred to as web applications 408. In FIG. 4, an HTTP request message is received by the web server device 400 via the network 350 initially at a network interface component 404, which can process and remove various network protocol layer headers and trailers before the message is passed to a message manager component 420 associated with a connection manager 430 of web server 410.

The received message can be, for example, an HTTP request that is associated with a transmission control protocol (TCP) connection created at the request of the client device 300 and accepted by the network interface component 404 of the web server device 400 as directed by the web server 410. The connection associated with the HTTP request can remain open to provide for full-duplex communication between the client device 300 and the web server 410. The connection manager 430 can be responsible for managing the input and output streams of the full-duplex connection to and from the web server 410. For example, the connection manager 430 has responsibilities that can include determining a component of the web server 410 or web application 408a-n to which to direct a received request.

The connection manager 430 can interoperate with a path manager 432 that, when provided with at least a portion of a path part of the URI associated with a request, can determine a web application from the web applications 408 available or a web server 410 component that can be responsible for handling requests associated with the at least a portion of the path part of the URI. The path manager 432 can access a table that associates at least a portion of a set of URI path parts with for example, a web application entry point, such as a java servlet through an application interface 406; or a web server 410 component, such as a file access handler 407. The table information used by the path manager 432 can be accessed via a configuration manager 440. The configuration manager 440 can be enabled to receive, store in a configuration database 450, and retrieve configuration data for components of web server 410 as well as web applications 408 and any web server 410 extensions or add-ons.

A variety of application interfaces are currently in use in addition to Java's J2EE platform interface between a J2EE container and a web server 410 including the well-known CGI interface. Most web servers supporting HTTP provide a file handler by default or as an add-on. A file handler is enabled to respond to HTTP GET, PUT, POST, and DELETE commands to operate on files and other static resources available to the web server 410 identified by a URI included in the request. The file access handler 407 in the web server device 400 interoperates with a file system 409 provided by and in conjunction with an operating system (not shown) of the web server device 400 to perform operations as directed on files in a file store 460, such as a hard-drive and other accessible resources provided through other components of the execution environment hosted on the web server device 400. Other services can be built into web servers in addition to file handlers.

With reference to FIG. 1, in block 100 a URI is received and formatted to include a URN scheme identifier for identifying a URN scheme, a scheme-dependent part for identifying a resource, and a URN scheme modifier for determining a URL for accessing the identified resource. A system for accessing a resource identified in a URI based on URN scheme modifiers includes means for receiving a URI formatted to include a URN scheme identifier for identifying a URN scheme, a scheme-dependent part for identifying a resource, and the URN-scheme modifier for determining a URL for accessing the identified resource. For example, as illustrated in FIG. 2, the URI handler component 200 can be configured for receiving a URI formatted to include a URN scheme identifier for identifying a URN scheme, a scheme-dependent part for identifying a resource, and the URN-scheme modifier for determining a URL for accessing the identified resource.

In one embodiment, the browser 310 in the client device 300 includes the URI handler component 200 embodied in a URI request handler component 200A configured to send messages of a particular URI scheme, and a URI response handler component 200B configured to receive messages of a particular scheme. Although one instance of the URI request 200A and response 200B handler components are shown, multiple instances can be provided based on multiple URI schemes. Similarly, the web server 410 in the server device 400 can include the URI handler component 200 in the form of a URI request/response handler component 200C configured to process requests to send messages and to receive messages of a particular URI scheme. Like the browser 310, the web server 410 can include multiple URI request/response handler components 200C for supporting multiple URI schemes.

The URI received by the URI handler component 200 can be a URN and/or a URL, and can be received in a variety of ways depending on the requirements of an application and/or execution environment receiving the URI. For example, in the browser 310, the URI request handler component 200A can receive the URI for performing the operation of sending a message based on the received URI.

In one embodiment, the URI is received via an input subsystem 302 as a result of a user typing the URI into a browser location bar, as a result of a selecting of a bookmark maintained by the browser 310, or as a result of a selecting of a link in the content of a presented web resource. The URI is passed to the browser's presentation controller 312, which includes an input router 314 that directs the URI to an appropriate component for processing. For example, the URI received via the browser's 310 location bar can be routed to a message manager 320 for directing the sending and receiving of messages. The message manager 320 routes the URI received from the input router 314 based on the scheme identifier of the URI. The URI is, thus, received by the URI request handler 200A compatible with the identified scheme as determined by the message manager 320.

With respect to an embodiment of the web server 410, the URI is received in the form of a request received via the network 350 from a client such as the browser 310 operating in the client 300. The request, in an embodiment is routed to a server message manager 420. Based on the scheme identifier included in a URI in the request and optionally based on additional request information, the message manager 420 invokes a URI request/response handler 200C for processing the request.

According to one embodiment, the received URI is formatted to include a URN scheme identifier for identifying a URN scheme, a scheme dependent part for identifying a resource, and a URN scheme modifier, which in general, provides information for specifying the handling of a URI in which the scheme modifier is used. Example 1 below depicts an example URI format that allows a scheme modifier to be included.

### EXAMPLE 1

<scheme name>;[<scheme modifier part>] : <hierarchical part>
[ ? <query> ] [ # <fragment> ]

As is shown, the URI format includes a “scheme modifier part” in addition to the conventional parts of the URI, i.e., the scheme name and the scheme dependent/hierarchical part. The scheme modifier part can be used, in an embodiment, to specify, among other things, a second scheme handling procedure for processing of the URI. This aspect is described in a co-pending patent application entitled, “Methods and Systems for Determining Scheme Handling Procedures for Processing URIs Based on URI Scheme Modifiers” (U.S. patent application Ser. No. 11/615,438), filed on Dec. 22, 2006, commonly owned with the present application, and incorporated here by reference in its entirety.

In one exemplary embodiment, the scheme modifier specifies information for determining a URL for accessing the resource identified by URI. This type of scheme modifier is referred to as a “resolving” scheme modifier. A resolving scheme modifier can include a resolving URL and/or a template for determining a resolving URL or the URL for accessing the resource. A resolving scheme modifier can be embodied in several ways. For instance, in one embodiment, the resolving scheme modifier can be a “location” scheme modifier that specifies a template for determining the URL for accessing the resource based on the template, or that specifies the URL for accessing the resource. Example 2 below depicts a set of four (4) URIs.

### EXAMPLE 2

(1) URN:ISBN:15625634
(2) URN:ISBN;location=”HTTP://www.ISBN.com/15625634”:15625634
(3) URN:ISBN;location=”HTTP://www.ISBN.com/%path%”:15625634
(4) URN:ISBN;location=”HTTP://
www.ISBN.com?id=%path%”:15625634

The first URI of Example 2 is a typical URN where the URN scheme is “ISBN” (International Standard Book Number) and the resource is identified by a serial number. As is typical of a standard URN, no information pertaining to where or how the resource can be accessed is provided.

The second, third and fourth URIs of Example 2 include “location” scheme modifiers. The second URI is an ISBN URN that includes the location scheme modifier that is assigned a value including a URL identifying a location for accessing the resource identified by the ISBN identifier portion. The third URI is a URN that includes a location scheme modifier that supports a predefined variable name “path” where a variable is identified by enclosing ‘%’ characters as defined in an exemplary schema for the “location” scheme modifier. In an embodiment, the % path % variable indicates that a URL for locating the resource can be constructed by inserting the URN path portion, e.g., 15625634, into a URL template assigned as the value of the “location” scheme modifier. The fourth URI is a URN similar to the third URN, except that the URL template includes a query portion including an “id” parameter assigned the % path % variable indicating that a URL for locating the resource can be constructed by replacing the % path % variable in the template with the path portion of the URN.

In another embodiment, a resolving scheme modifier can include a resolving URL for accessing a resolving entity that is configured to provide for determining the URL for accessing the resource. For instance, such a scheme modifier can be a “resolver hint” scheme modifier that specifies a res-hint URL for accessing a hint entity for identifying a resolver URL for accessing a resolver entity. Optionally, a protocol for communicating with the resolver entity can be specified. Example 3 provides syntax for a “resolver hint” scheme modifier in one embodiment, and two URIs.

### EXAMPLE 3

```
Syntax:
    res-hint=”url{;starting-point][;type-model]” where
      starting-point = ″;scope=″ resolution-starting-pt
      type-model = ″;type=″ type-specifier * ( ″+″ type-specifier )
      type-specifier = URN
URN:ISSN:2378-7534
URN:ISSN;res-hint=”HTTP://myhint.server.com”:2738-7534
```

The syntax is based on a “res-hint” HTTP header defined in “WIRE—W3 Identifier Resolutions Extensions” by Girod, et al., proposed for HTTP in IETF draft-griod-w3-id-res-ext-00.txt. In a related document entitled “URN Resolution Using WIRE” by Girod, et al., in IETF draft-girod-URN-res-using-wire-00.text, a hint as specified in a res-hint header “contain[s] the location and a protocol of a resolver.” The URIs in Example 3 includes an ISSN scheme identifying a URN namespace for the “Science of Computer Programming” journal. The path portion comprises a serial number of a particular edition of the journal. The first URI is an ISSN URN with no scheme modifiers, while the second URI is an ISSN URN including a “resolver hint” scheme modifier providing the address of a suggested resolver.

Another scheme modifier that includes a resolving URL can be a “last-location” scheme modifier that specifies a last-location URL for accessing a last-location entity identified as a last known location of the resource. Example 4 illustrates a “last location” scheme modifier allowing a client, a server, and/or resolving entity to provide the last known location of a specified URN known to the provider of a “last-location” scheme modifier when constructing a URI. The first URI is a WEB3D URN with no scheme modifiers, while the second URI is a WEB3D URN including a last-location scheme modifier. A component using the URI can use the “last location” scheme modifier to attempt to locate the identified resource at the location identified in the scheme modifier.

### EXAMPLE 4

URN:WEB3D:x3d:schemas:2002:compact
URN:WEB3D;last-location=”HTTP://schemas.org/
x3d/compact”: ♯x3d:schemas:2002:compact

In another aspect, a scheme modifier that includes a resolving URL can be a “resolver” scheme modifier that specifies a resolver URL for accessing a resolver entity for resolving the URN to the URL for accessing the resource. Example 5 illustrates two URIs, the first of which is an MPEG URN with no scheme modifiers, and the second of which is an MPEG URN including an exemplary “resolver” scheme modifier for specifying a resolver to use in locating the specified resource.

### EXAMPLE 5

URN:MPEG:mpeg7:schema:2001
URN:MPEG;resolver=”ftp://ftp.MPEG.com/resolver”:mpeg7:schema:2001

The “resolver” scheme modifier, in an embodiment, differs from a “resolver hint” scheme modifier in that its value is intended to identify a resolver entity known to be configured to resolve the URI. A “resolver” scheme modifier may be appropriate, as may the other described examples, for including in, for example, a URI in a link in a document for accessing a resource identified by the URI. In one embodiment, a “resolver” scheme modifier must be used, whereas a “resolver hint” scheme modifier can be ignored, used as a primary, or as a secondary resolver. Such a scheme modifier allows a content developer to include a link using a URN that identifies to a client the resolver providing for reliable and perhaps more rapid resolution of the including URN than a device's configured resolver or resolver cache information.

In another embodiment, a scheme modifier can be a “transport” scheme modifier that specifies a transport protocol to use for transporting a message associated with the URI. The “transport” scheme modifier can augment information provided by other scheme modifiers, such as a “resolver hint” scheme modifier. Example 6 illustrates a “transport” scheme modifier that augments information provided by a “resolver hint” scheme modifier, suggesting a resolver is included. In this example, the “transport” scheme modifier indicates that the resolver should be contacted by means of the HTTP transported over UDP rather than TCP as is typical. Additionally, the “transport” scheme modifier suggests two UDP ports to try.

### EXAMPLE 6

URN:oid;res-hint=”HTTP://myhint.server.com”;
transport=”udp:10020:1021”:ISO%2FIEC+10179%3A1996:
DTD_DSSSL+ARCHITECTURE:EN

In another embodiment, a scheme modifier can be an “alternate” scheme modifier that specifies an alternate resolver and/or an alternate content provider for providing the identified resource. Example 7 depicts a URI that includes an exemplary “alternate” scheme modifier.

### EXAMPLE 7

ftp;alternate=”HTTP://sceneraresearch.com/shared/rfc1352::
//ftp.scenerarearch.com/shared/rfc1352

In one embodiment, the “alternate” scheme modifier can be included in a URL, as depicted in Example 7, as well as in a URN. In this example, the alternate scheme modifier suggests an alternate HTTP URL for accessing the resource, e.g., RFC 1352, in addition to a primary FTP URL.

In another embodiment, a scheme modifier can be a “substitute” scheme modifier that identifies a resource that can be used instead of the identified resource. Example 8 depicts a “substitute” scheme modifier.

### EXAMPLE 8

HTTP;substitute=HTTP://advanced.math.com/evaluate?%QUERY%:
//everyday.math.com/calculate?expression=”100x(1.05)exp5”

Once again, the “substitute” scheme modifier can be included in URLs as well as in URNs, as is the case in all the examples, because scheme modifiers can be included in URIs in general. In the example, an HTTP request can be sent to the identified URL, e.g., “everyday.math.com,” for receiving a response including a result of an evaluation of the value of an expression parameter. The “substitute” scheme modifier provides an identifier for locating a substitute service.

The URIs described in Examples 2-8 use various location related scheme modifiers associated with determining a location of an identified resource. While numerous, the described example scheme modifiers are certainly not exhaustive as those skilled in the art would readily appreciate.

Returning to FIG. 1, in block 102 the URN scheme modifier is detected in the received URI. Accordingly, a system for accessing a resource identified in a URI based on URN scheme modifiers includes means for detecting the URN scheme modifier in the received URI. For example, as illustrated in FIG. 2, a URI parser component 204 is configured for detecting the URN scheme modifier in the received URI.

In one aspect, the URI parser component 204 is configured for parsing the URI for detecting a scheme modifier in the received URI. For example, a URI received by the URI handler component 200 is provided to the URI parser 204 for parsing the URI into its parts. In some embodiments, the URI parser 204 is a validating parser that locates and/or is provided with a schema defined for specifying valid URIs. For example, returning to FIG. 3 and FIG. 4, in an exemplary embodiment, the URI parser component 204 in either of the URI request handler component 200A or the URI request/response handler component 200C, can provide a representation of various portions of the URI to a URI model 206 for access via an API (not shown) provided by the URI model 206. The URI model 206 can be a data structure, an instance of a class generated from source code written in an object oriented source language, and/or a record in a database, for example.

In an embodiment of a URI model 206, each URI instance is associated with a data structure where portions of the URI correspond to valid portions of a URI as specified by the corresponding schema. For example, the URI,

HTTP;substitute=HTTP://advanced.math.com/evaluate?%QUERY%:
//everyday.math.com/calculate?expression=”100x(1.05)exp5”

can be associated with a structure including a variable for storing the scheme, a variable for storing a host name and/or address, a variable for optionally storing a port number, a variable or variables for optionally storing a path or portions of a path, a variable for optionally storing a fragment identifier, and a variable, such as a 2 by n array for optionally storing keyword-value pairs of a query portion, where n is greater than or equal to the number of keyword-value pairs.

Functions for reading and writing portions of the URI can be provided by the URI model 206 and/or can be provided via an optional model interface (not shown). In some embodiments, the model interface can provide an API for components external to the URI handler component 200A-200C. The data structure and functions, in some embodiments, can be encapsulated in one or more classes in an object oriented embodiment.

In one embodiment, scheme specific functions associated with processing specific portions of a URI can be provided in a library of scheme handling functions 202. For example, a function can be provided that retrieves a host name portion of the URI via the model interface or directly from the URI model 206 when no API is provided. The exemplary function can provide the host name to a domain name service (DNS) client with which it is operatively coupled (not shown). The DNS client can be configured to communicate with a DNS server for resolving the host name portion of the URI to a network address.

According to one embodiment, the URI parser component 204 parses the received URI and detects the URN scheme modifier. When a scheme modifier is unrecognized by the URI handler component 200, it can be ignored in one embodiment. Alternatively, the URI handler 200 can generate an error via the URI parser component 204 and/or the URI model 206.

Returning to FIG. 1, in block 104 the URL for accessing the resource is determined based on the detected URN scheme modifier. Accordingly, a system for accessing a resource identified in a URI based on URN scheme modifiers includes means for determining, based on the detected URN scheme modifier, the URL for accessing the resource. For example, as illustrated in FIG. 2, a resolver library component 210 is configured for determining, based on the detected URN scheme modifier, the URL for accessing the resource.

In one embodiment, the resolver library component 210 can query the URI model 206 for determining scheme modifiers that can affect the processing of a request associated with a URI. Alternately, the URI model 206 can provide scheme modifier data to the resolver library 210 without solicitation from the resolver library 210. Variables used in scheme modifiers, such as the exemplary % path % variable, can be resolved by the URI model 206, the URI parser 204, and/or the resolver library 210 depending on the embodiment.

According to an exemplary embodiment, the resolver library component 210 comprises a plurality of functions for assisting in locating a resource identified by a URI. Depending on the particular scheme modifier(s), the resolver library component 210 is configured to select a resolver function based on the scheme modifier for performing processing to determine the URL for accessing the resource.

For example, for the second, third, and/or fourth URIs depicted in Example 2 above, the resolver library 210, in an embodiment, can access a “location” function for processing the “location” scheme modifier. The “location” function can, for example, provide for building and sending an HTTP request to the location identified by the value of the “location” scheme modifier, e.g., www.ISBN.com, using the URL provided with any variables resolved. Thus, the resolver library 210 can provide for an HTTP request to be sent to the host, www.ISBN.com, including the URL, HTTP://www.ISBN.com/15625634.

In the client device 300 depicted in FIG. 3, the resolver library 210 can be embodied as a portion of the library of scheme handling functions 202. Thus, the “location” function included in the resolver library 210 for processing the location scheme modifier is located and invoked in response to detecting the “location” scheme modifier. The “location” function receives the value of the “location” scheme modifier from the URI model 206. Detecting that the value of the “location” scheme modifier is an HTTP URL, the function determines that the provided URL identifies the location of the resource.

In one embodiment, the location function can retrieve a template for an HTTP GET command from a templates database 325 for storing and retrieving protocol command templates. The location function fills in the template based on the URL associated with the “location” scheme modifier. In one embodiment, the URL included in the scheme modifier can include scheme modifiers of its own for processing affecting the building of the HTTP GET command. The location function can provide for the HTTP request to be sent to the host, www.ISBN.com, including the URL, HTTP://www.ISBN.com/15625634. Messages sent and received by the browser 310 are sent and received via a network interface 304 including a network stack interoperating typically with an application protocol layer 330 such as an HTTP protocol layer, an FTP protocol layer, a SIP protocol layer, and/or an XMPP protocol layer.

In the server device 400 depicted in FIG. 4, the URIs in Example 2 can be included in a resource generated by a web application 408 hosted by the web server 410. Web applications 408 can be invoked via a web application interface 406 such as cgi-bin, J2EE interfaces, and .NET interfaces. The URIs in Example 2, alternately, can be included in a static resource stored on a file store 460 of the server device 400. The file store 460 can be accessed via a file system 409 included in the execution environment of the device 400. Files are accessible as resources by the web server 410, in an embodiment, through a file access handler 407. The request is received via the network 350 from a requesting client by a network interface 404 included in the execution environment of the device 400.

The request received by the network interface 404 is subsequently received by the message manager 420. The message manager 420 provides information based on the request including URL information as detected by the URI request/response handler 200C to a connection manager 430 configured to maintain a connection for responding to the received request. The connection manager 430 routes the request information as instructed by a path manager 432. The path manager 432 is configured to maintain associations between path information and available request processors, such as the web applications 408 and the file access handler 407. The path manager 432, in an embodiment, receives the path information required to determine an appropriate request processor from the connection manager 430. In an alternate embodiment, the required information can be received from the message manager 420. In the web sever 410, the request information is received by a web application 408 and/or a file access handler 407 configured to access a particular resource identified by the URL included in the request.

If the resource is located and/or generated, the resource is provided via the connection manager 430 to the message manager 420 for constructing a response for returning the identified resource. The response can include scheme modifiers in a URI returned in the response. If the resource is not located, the message manager 420 can construct a response including a scheme modifier associated with locating the resource inserted into the URI allowing the requester to continue determining a URL identifying the location of the identified resource. In another example, where the resource is not located, the web server 410 can include a resolver client 220 configured to communicate using a resource resolution protocol with a resolver 470 for determining a URL identifying the location on behalf of the requesting client. The web server 410 can include in the request to the resolver 470 the location associated scheme modifiers.

For the URI in Example 3 above, the resolver library 210, in an embodiment, can access a “resolverHint” function for processing the “resolver hint” scheme modifier. In an embodiment, the “resolverHint” function in the resolver library 210 provides for sending an HTTP request to the hint entity, myhint.server.com, according to a resource resolution protocol such as WIRE supported by the resolver client 220. The hint entity can return a URL for accessing the identified resource or the hint entity can provide information either to the requesting client or to another device to continue the resource resolution process.

In the client device 300, the resolver library 210 locates a resolverHint function for processing the “resolver hint” scheme modifier. The resolverHint function is located and invoked based on the value associated with the “resolver hint” scheme modifier. The resolverHint function receives the value of the “resolver hint” scheme modifier from the URI model 206 in an embodiment. Detecting that the value of the “resolver hint” scheme modifier is an HTTP URL, the function retrieves a template for an HTTP command compatible with the resource resolution extensions from the templates database 325. The resolverHint function fills in the template based on the URL associated with the “resolver hint” scheme modifier and sends the request for determining a URL identifying a location of the resource.

The URI in Example 4 can be processed in a similar manner as described above. In this case, a “last location” function is located. In an embodiment, the “last location” function sends a query to the URL in the “last-location” scheme modifier to determine whether the resource is still present at the identified location. If a positive response is received, a request is made to the location to access the resource. A negative response can return no information of use in locating the resource or can include as header information and/or as scheme modifiers in the URI in the response information such a new value for last location, a resolver hint, and/or any combination of scheme modifiers and headers relating to location that is accessible to the responding device.

The URI in Example 5 identifies a preferred resolver for the URI in the “resolver” scheme modifier. The receiver of the URI can query the identified resolver rather than using the resolver(s) configured for the device. Processing is analogous to scheme modifier processing previously described with respect to the client device 300 and the server device 400. Each system can use the scheme modifier as a receiver of the URI and/or insert the resolver scheme modifier in a URI based on information available to the device 300, 400 as a sender. Once a request is sent to the identified resolver entity, the message can be sent to other resolver entities and/or returned to the requesting device until a location for accessing the identified resource is determined.

The URI in Example 6 can be processed as described above relating to the “resolver hint” scheme modifier. The presence of the “transport” scheme modifier overrides the default transport protocol, TCP, used for HTTP. In this case, a “transport” function is located by the resolver library 210. The HTTP command processor invokes the transport function indicating the HTTP request is to be sent via user datagram protocol (UDP) and any response is to be received via a corresponding UDP port. The specified ports allow the resolver library 210 to send the resolver hint request to at least one of the two identified ports.

The URIs in Example 7 and Example 8 can be processed in the manner described above. A receiver of the URI is provided with more than one location for accessing the identified resource or for receiving a similar service and/or resource, respectively. The receiver can be allowed to attempt to access the resource using as few or as many of the identified locations as the receiver is configured to use. The alternative or substitute URLs can be used, for example, when the primary location is unavailable, and/or is not responding in a timely fashion.

While the examples illustrate the processing of one or two related scheme modifiers related to location determination for a resource identified by a URI, the scheme modifiers described can be used in numerous combinations in the same URI and/or in a sequence of messages including URIs with scheme modifiers added, removed, and/or altered as messages are exchanged between and/or among devices involved in locating the identified resources. In one embodiment, while determining the URL for accessing the resource, the requesting device, e.g., the client device 300, can receive a response that includes a URI with a location associated scheme modifier. In this case, the URI can be received by a URI response handler 200B for processing. Based on the scheme modifier received as detected by response parser 254 interoperating with a URI parser 204, the URI response handler 200B can cause the message manager 320 to invoke a URI request handler 200A to send another message for determining a URL identifying a location of the resource.

In one embodiment, when the URL for accessing the resource is not determined within a specified time period, the determining process can be terminated. Otherwise, when the URL for accessing the resource is determined, a request addressed based on the determined URL can be generated and sent to the entity identified by the determined URL. A response including a portion of the resource and/or access information enabling at least a portion of the resource to be accessed can be received by the URI response handler 200B. Responses received by the URI response handler 200B that include the identified resource are parsed by the response parser 254 and passed to the message manager 320, which provides resource content to a content handler component (not shown) based on the type of the content via a content manager (not shown).

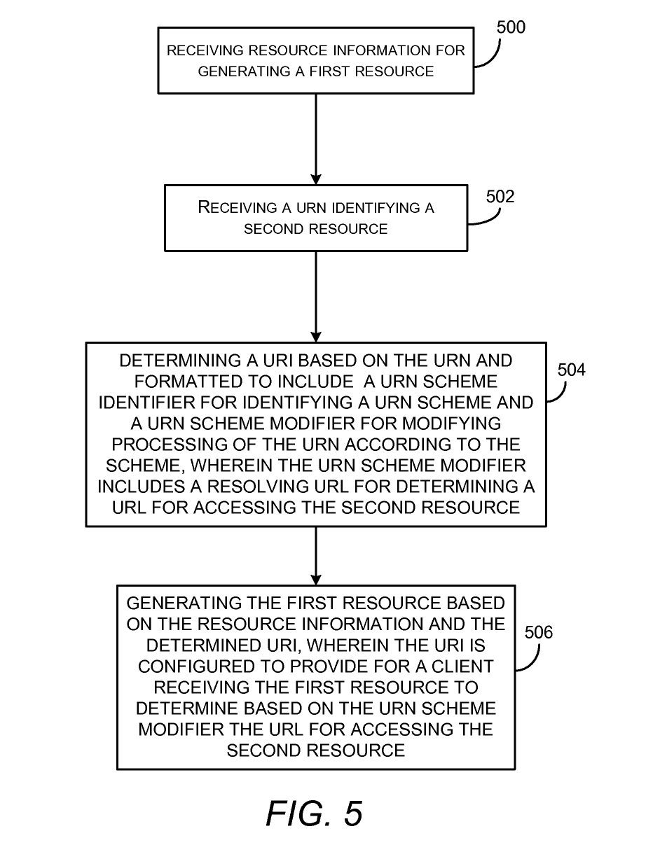

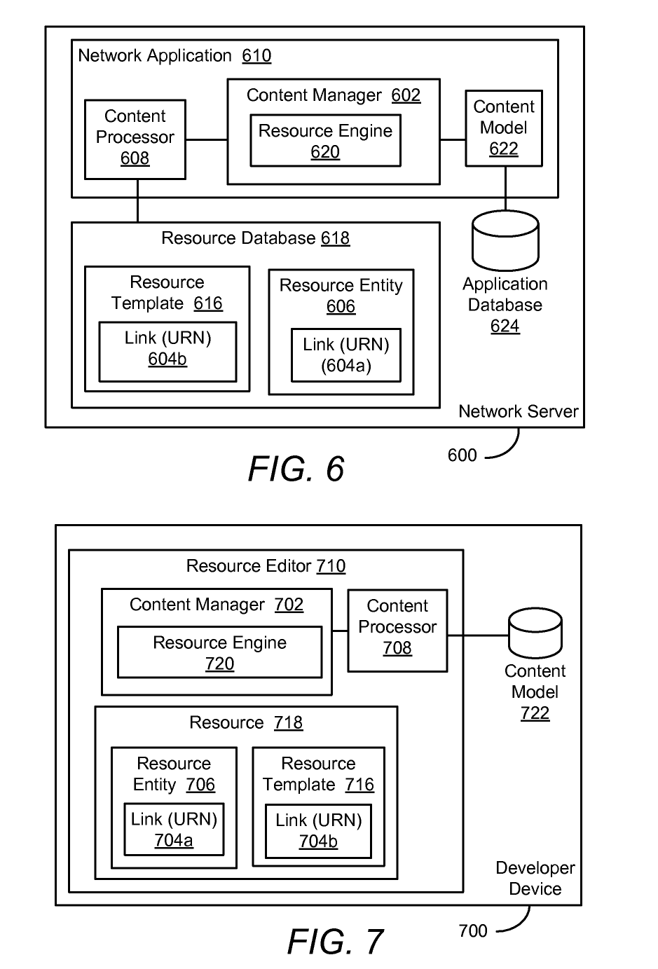

FIG. 5 is a flow diagram illustrating a method for providing a resource including a URN configured for accessing another resource according to another aspect of the subject matter described herein. FIGS. 6 and 7 are block diagrams illustrating systems for providing a resource including a URN configured for accessing another resource according to other embodiments. In particular, FIG. 6 illustrates a network server device 600 and FIG. 7 illustrates a resource developer device 700 both configured for providing a resource including a URN configured for accessing another resource.

With reference to FIG. 5, in block 500 resource information for generating a first resource is received. A system for providing a resource including a URI configured for accessing another resource based on a URN scheme modifier includes means for receiving resource information for generating the first resource. For example, as illustrated in FIG. 6 and FIG. 7, a content manager component 602, 702 can be configured for receiving resource information for generating the first resource.

According to one embodiment, the network device 600 includes a network application 610 configured to generate or send resources to a device in response to a request from the receiving device or without solicitation from the receiving device. The network application 610, for example, can be an FTP application, an instant message application, a presence application, and/or an email application. The network application 610 operates in an execution environment of the network device 600 and optionally a network server application container (not shown) such as a J2EE container. The execution environment, for example, includes a processor, processor memory, secondary storage, an operating system or control program, and a communication subsystem. In one embodiment, the network application 610 includes a content manager component 602 configured to receive resource information such as a resource entity 606 and/or a resource template 616 from a memory location such as a resource database 618 via a content processor component 608.

The content manager component 602 can alternatively or additionally be configured for receiving information from a content model 622. The content model 622 maintains variable data for filling in portions of a resource. Stored data for providing as resource information to the content manager 602 can be stored in an application database 624 accessible by the content model 622. The structure of the database 624 can define some or all of a data model for the network application 610. There are numerous other sources of resource information including network application configuration data, and/or data received from external sources such as other services and/or clients.

In another embodiment, the developer device 700 includes a resource editor 710 for generating network accessible resources, such as markup-language-based resources. The resource editor 710 operates within an execution environment provided by the developer device 700. The execution environment can include, for example, a processor, processor memory, secondary storage, and an input/output system supporting devices such as a display, a keyboard, a mouse, and a disk driver. The execution environment can provide a communication subsystem (not shown) for allowing a generated resource to be transmitted to a device, such as the network server 600 via a network (not shown) for use in the network application 610. The resource editor 710 includes a content manager component 702 for receiving resource information, such as a resource entity 706 and/or a resource template 716, for generating the first resource. Additionally or alternatively, the content manager 702 can receive input from a user via an editor user interface (not shown) as resource information for generating the first resource. The content manager 702 can receive information from a variety of other sources, including user profile information, resource editor configuration, and/or other applications operation locally and/or remotely.

Returning to FIG. 5, in block 502 a URN identifying a second resource is received. The system for providing a resource including a URI configured for accessing another resource includes means for receiving a URN identifying a second resource. For example, as illustrated in FIG. 6 and FIG. 7, the content manager component 602, 702 can be configured for receiving a URN for identifying a second resource.

In an example, a URN 604a included in a link can be received in the resource entity 606 by the content manager 602 as described above. The resource entity 606, for example, can be a markup-language based resource entity, such as an HTML page. Alternatively or additionally, a URN 604b included in a link can be similarly received in the resource template 616 by the content manager 602 via the content processor 608 loading the resource template 616 from the resource database 618. Alternatively or additionally, a URN 604 can be received by the content manager 602 from the content model 622. The content manager 602 can provide request information to the content model 622. Based on the request information, the content model 622 can retrieve information from an application database 624 as resource information for generating the first resource. The content model 622 can additionally or alternatively be configured for dynamically generating, based on, for example the request or retrieved data, a URN 604 and associating the generated URN 604 with a second resource for identifying the second resource.

Similarly, in the developer device 700, the content manager 702 is configured to receive a URN 704a, for example, in a link included in a resource entity 706, and/or a URN 704b in a link included in a resource template 716 for guiding a user in creating the resource 718 loaded by the resource editor 710. Alternatively or additionally, a URN 604 can be received via an input device manipulated by a user.

In the developer device 700, as the content manager 702 receives the resource information, the resource engine 720 issues commands to the content processor 708 for building a content model 722 of the resource. For example, if the resource 718 is an XML-based resource, the content processor 708 manages a DOM depicted as a content model 722. The content processor 708 can be configured to validate input based on one or more schemas to which the resource 718 is configured to conform.

In one embodiment, a resource template 716 compatible with the resource 718 is included in the resource 718 for assisting the user in providing input for generating the resource. The resource template 716 can include a URN. The resource template 716 can also provide a variable or placeholder where a URN including a scheme modifier provided by the user can be inserted into the resource template 716 and thus into the resource 718. Additionally, a preexisting pre-generated resource entity 706 can be included in the resource editor 710 as well where the pre-generated resource entity 706 includes a URN as previously described.

Returning to FIG. 5, in block 504 a URI is determined. The URI is based on the URN and formatted to include the URN, a URN scheme identifier for identifying a URN scheme, and a URN scheme modifier for modifying processing of the URN according to the scheme. The URN scheme modifier includes a resolving URL for determining a URL for accessing the second resource. The system for providing a resource including a URI configured for accessing another resource includes means for determining a URI based on the URN and formatted to include a URN scheme identifier for identifying a URN scheme and a URN scheme modifier for modifying processing of the URN according to the scheme. The URN scheme modifier includes a resolving URL for determining a URL for accessing the second resource. For example, as illustrated in FIG. 6 and FIG. 7, the resource engine component 620, 720 can be configured for determining a URI based on the URN and formatted to include a URN scheme identifier for identifying a URN scheme and a URN scheme modifier for modifying processing of the URN according to the scheme. The URN scheme modifier includes a resolving URL for determining a URL for accessing the second resource.

The URN 604a in the resource entity 606 can be modified by the resource engine 620 to include, for example, a “resolver” scheme modifier. The “resolver” scheme modifier can include a “resolver” URL as a resolving URL as described above. The resource engine 620 can determine the resolving URL based on a configuration parameter of the network application 610. The configuration parameter can include a resolving URL of, for example, a resolver entity and/or a res-hint entity for use with a “res-hint” scheme modifier. The resource engine 620 can be configured to determine a resolving URI based on detecting a URN in received information and on an identifier or the requested resource and/or based on any part of the detected URN.

Other detectable attributes can affect the resource engine 620 in determining the resolving URL based on the configuration of the resource engine 620. The URN 604a modified to include the “resolver” scheme modifier based on the determination is a URI based on the URN 604a. The URI format includes the URN scheme identifier of the URN 604a for identifying the URN scheme. Additionally, the URI format includes the URN scheme modifier for modifying the processing of the URN based on the URN scheme modifier including the resolving URL. The processing of the URI is modified for determining a URL for accessing the second resource via a request addressed to the resolving URL.

Additionally or alternatively, the content processor 608 can be configured to track resources provided by the network application 610. When a resource is relocated from the network application 610, the content processor 608 can associate an identifier of the relocated resource with a “last location” URL. For example, when the second resource has been relocated, the “last location” can be the URL of a location the second resource was relocated to from the network application 610. The association can be created based on input from an administrator of the network application 610 or can be created automatically by the content processor 608 in a response to a request to relocate the second resource to an identified location.

When a request based on a URL for the second resource is received by the content manager 602, the content processor 608 can be called to retrieve resource information for generating a second resource. The URL is also a URN. The content processor 608 detects the association of the second resource with the “last location”. The content processor 608 returns the “last location” information in or as resource information to the content manager 602. The content manager 602 receives the resource information including the “last location” information and provides the resource information to the resource engine 620 for determining the resolving URL. The resource engine 620 determines the resolving URL based on the “last location” information. The content processor 608 can additionally be configured to return “resource hint” information, “resolver” information, and/or any other resolving information configured and/or detected during the operation of the network application 610.

The resource engine 620 can be configured to determine an associated resolving URL based on the resolving information received in and/or along with associated resource information. The resource engine 620 can be configured to modify the URL, which is also a URN, received in the request to a URI including a resolving scheme modifier. A value portion of the resolving scheme modifier is set to the determined resolving URL completing the determining of the URI. The URI is formatted as described above.

A URN 604b can be included in a resource template 616. The process of determining a URI including a scheme modifier with a resolving URL is analogous to that described above with respect to the URN 604a received in association with the resource entity 606.

In FIG. 7, the resource engine 720 can be configured for performing operations analogous to those described for the resource engine 620 for determining a resolving URL. For example, a resource editor 710 can be configured with a resolver URL. A URI can be determined by the resource engine 720 as described above. A scheme modifier including the determined resolving URL can be included in the received URN creating the URI. The URI 704 is formatted to include the scheme identifier of the URN for identifying a URN scheme and the URI scheme modifier including the resolving URL for determining a URL for accessing the second resource.

Returning to FIG. 5, in block 506 the first resource is generated based on the resource information and the determined URI. The URI is configured to provide for a client receiving the first resource to determine the URL for accessing the second resource based on the URN scheme modifier. The system for providing a resource including a URN configured for accessing another resource includes means for generating the first resource based on the resource information and the determined URI, wherein the URI is configured to provide for a client receiving the first resource to determine based on the URN scheme modifier the URL for accessing the second resource. For example, as illustrated in FIG. 6 and FIG. 7, the resource engine 620, 720 can be configured for generating the first resource based on the resource information and the determined URI, wherein the URI is configured to provide for a client receiving the first resource to determine based on the URN scheme modifier the URL for accessing the second resource.

For example, in the network device 600, as described above, when the resource entity 606 is retrieved, the content processor 608 provides the resource entity 606 to the content manager 602. The content manager 602 interoperates with the resource engine 620 for determining the URI based on the received URN and the determined resolving URL. The resource engine 620 can be further configured for generating content for any other portion of the first resource in the generation of the first resource based on the resource information and the determined URI. The resource can include content of any type supported by a generating application. For example, the first resource can include HTML content, script content, image data content, audio content, and the like. The first resource is generated by the resource engine 620 based on the received resource information, for example, the resource entity 606, and the determined URI including the scheme modifier with the resolving URL, for example, the URI determined based on the URN 604a.

The content manager 602 can generate a message including the generated first resource. For example, when the resource template 616 is received as resource information by the content manger 602, and the resource engine 620 determines the URI including the scheme modifier with the resolving URL based on the URN 604b, the resource engine 620 generates the first resource based on the received resource information and the determined URI. The first resource is included in the message generated by the content manager 602 for transmitting to a receiving client.

The receiving client in processing the first resource can present the link including the determined URI allowing a user of the link to access the second resource via a URL determined based on the resolving URL included in the scheme modifier in the URI. This process is described above.

As mentioned in generating the first resource, the resource engine 620 interoperating with the resource manager 602 can determine what, if any, data is required for finalizing the generation of the first resource based on the received resource information and determined URI, such as the resource entity 606 and/or the resource template 616. The data can be determined based on the data model 622 for the first resource.

Based on the determination of the content manager 602, a content model 622 component can be invoked that can be configured to retrieve required data from an application database 624 and/or configured to generate required data based on information in the received message, information in the application database 624, and/or information based on any data accessible to the model 622. Some embodiments can include multiple model components 622 as well as multiple content processor components 608 where a content processor 608 and/or a model 622 is associated with a received message based on information associated with the message such as a portion of a URI included in the received message.

The content manager 602, in an embodiment, further determines an appropriate format for the message to be sent including the determined URI and additional, possibly optional model data. In some cases, the determined URI included in the generated resource is provided by the content model 622 and included in the resource during the generation process by the resource engine 620. In one embodiment, the resource engine 620 completes the generation of the resource based on the variable portions of the resource template 616 and/or resource entity 606 and the data provided by the model 622.

For example, in the network device 600, the content manager 602 can send the generated first resource including the URI with the scheme modifier to a recipient, such as the client device 300 depicted in FIG. 3 via the message. The recipient device 300 includes a URI handler component 200 including a parser 204 for detecting the scheme modifier, and a resolver library component 210 for invoking a function to perform processing indicated by the scheme modifier for determining a URL for accessing the second resource. The recipient device 300 can then use the URL for accessing the second resource identified by the URI included in the received resource.

In the developer device 700, the resource 718 generated by the resource engine 720 based on at least one of the resource entity 706, the resource template 716, and data received from a user or any other source includes a URN. The resource engine 720 can be configured for performing one or more of operations performed by the resource engine 620 for determining a URI based on the URN. The operations described for determining the URI are exemplary and not exhaustive. The determined URI includes a scheme modifier for indicating a processing option for processing the URI to identify a URL for accessing the second resource. The content model 722 can be configured to store the resource 718 in a format compatible with the schema in secondary storage (not shown). Alternatively or additionally, the generated resource 718 can be transmitted, via a communication subsystem (not shown), to a device, such as the network server 600 for use in the network application 610.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components can be added while still achieving the functionality described herein. Thus, the subject matter described herein can be embodied in many different variations, and all such variations are contemplated to be within the scope of what is claimed.

To facilitate an understanding of the subject matter described above, many aspects are described in terms of sequences of actions that can be performed by elements of a computer system. For example, it will be recognized that the various actions can be performed by specialized circuits or circuitry (e.g., discrete logic gates interconnected to perform a specialized function), by program instructions being executed by one or more processors, or by a combination of both.

Moreover, executable instructions of a computer program for carrying out the methods described herein can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

Thus, the subject matter described herein can be embodied in many different forms, and all such forms are contemplated to be within the scope of what is claimed. It will be understood that various details of the invention may be changed without departing from the scope of the claimed subject matter. Furthermore, the foregoing description is for the purpose of illustration only, and not for the purpose of limitation, as the scope of protection sought is defined by the claims as set forth hereinafter together with any equivalents thereof entitled to.

What is claimed is:

1. A method for accessing a resource based on URN scheme modifiers, the method comprising:
receiving a URI formatted to include a URN scheme identifier for identifying a URN scheme, a scheme-dependent part for identifying a resource, and a URN scheme modifier for determining a URL for accessing the identified resource;
detecting the URN scheme modifier in the received URI; and
determining, based on the detected URN scheme modifier, the URL for accessing the resource.

2. The method of claim 1 wherein receiving a URI includes receiving a URI at a client device via at least one of a location bar of a browser and a link selected in presented content.

3. The method of claim 1 wherein the URN scheme modifier includes a location scheme modifier specifying one of a template for determining the URL for accessing the resource based on the template and the URL for accessing the resource.

4. The method of claim 1 wherein receiving a URI includes receiving a URN in a message received via a network.

5. The method of claim 1 wherein the URN scheme modifier includes a resolving URL for accessing a resolving entity, and wherein determining the URL for accessing the resource includes generating a message including a request for resolving the URL for accessing the resource, and accessing the resolving entity by sending the message addressed with the resolving URL to the resolving entity.

6. The method of claim 5 wherein the URN scheme modifier including the resolving URL is at least one of a resolver scheme modifier specifying a resolver URL for accessing a resolver entity for resolving the URN to the URL for accessing the resource on behalf of a requesting client, a resolver hint scheme modifier specifying a res-hint URL for accessing a hint entity for identifying a resolver URL for accessing a resolver entity and specifying a protocol for communicating with the resolver entity, and a last-location scheme modifier specifying a last-location URL for accessing a last-location entity identified as a last known location of the resource.

7. The method of claim 6 wherein determining the URL for accessing the resource includes receiving at least one of a resolver URL for accessing a resolver entity, a res-hint URL for accessing a hint entity, a last-location URL for accessing a last-location entity, the resource, and the URL for accessing the resource in response to the message sent to the resolving entity accessed via the resolving URL included in the URN scheme modifier.

8. The method of claim 1 further comprising selecting a transport protocol to use for transporting a message associated with the URI, wherein the transport protocol is selected based on the detected URN scheme modifier.

9. The method of claim 1 wherein the URN scheme modifier includes a URL associated with at least one of an alternate and substitute content provider for providing the resource.

10. The method of claim 1 further comprising terminating the determining step when the URL for accessing the resource is not determined within a predetermined time period.

11. The method of claim 1 further comprising:
generating a request addressed based on the determined URL for accessing the resource;
sending the request to an entity identified by the determined URL; and
receiving a response including at least one of a portion of the resource and access information enabling at least a portion of the resource to be accessed.

12. A system for accessing a resource based on URN scheme modifiers, the system comprising:
a URI handler component configured for receiving a URI formatted to include a URN scheme identifier for identifying a URN scheme, a scheme-dependent part for identifying a resource, and a URN scheme modifier for determining a URL for accessing the identified resource;
a URI parser component configured for detecting the URN scheme modifier in the received URI; and
a resolver library component configured for determining, based on the detected URN scheme modifier, the URL for accessing the resource.

13. The system of claim 12 wherein the URI handler component is configured for receiving a URI at a client device via at least one of a location bar of a browser and a link selected in presented content.

14. The system of claim 12 wherein the URN scheme modifier includes a location scheme modifier specifying one of a template for determining the URL for accessing the resource based on the template, and the URL for accessing the resource.

15. The system of claim 12 wherein the URI handler component is configured for receiving a URI in a message received via a network.

16. The system of claim 12 wherein the URN scheme modifier includes a resolving URL for accessing a resolving entity, and wherein the resolver library component is configured for generating a message including a request for resolving the URL for accessing the resource, and accessing the resolving entity by sending the message addressed with the resolving URL to the resolving entity.

17. The system of claim 16 wherein the URN scheme modifier including the resolving URL is at least one of a resolver scheme modifier specifying a resolver URL for accessing a resolver entity for resolving the URN to the URL for accessing the resource on behalf of a requesting client, a resolver hint scheme modifier specifying a res-hint URL for accessing a hint entity for identifying a resolver URL for accessing a resolver entity and specifying a protocol for communicating with the resolver entity, and a last-location scheme modifier specifying a last-location URL for accessing a last-location entity identified as a last known location of the resource.

18. The system of claim 17 wherein the resolver library component is configured for receiving at least one of a resolver URL for accessing a resolver entity, a res-hint URL for accessing a hint entity, a last-location URL for accessing a last-location entity, the resource, and the URL for accessing the resource in response to the message sent to the resolving entity accessed via the resolving URL included in the URN scheme modifier.

19. The system of claim 12 wherein the resolver library component is configured for selecting a transport protocol to use for transporting a message associated with the URI, wherein the transport protocol is selected based on the detected URN scheme modifier.

20. The system of claim 12 wherein the URN scheme modifier includes a URL associated with at least one of an alternate and substitute content provider for providing the resource.

21. The system of claim 12 wherein the resolver library component is configured for terminating the determining step when the URL for accessing the resource is not determined within a predetermined time period.

22. The system of claim 12 wherein the URI handler component is configured for generating a request addressed based on the determined URL for accessing the resource, sending the request to an entity identified by the determined URL, and receiving a response including at least one of a portion of the resource and access information enabling at least a portion of the resource to be accessed.

23. A system for accessing a resource based on URN scheme modifiers, the system comprising:
means for receiving a URI formatted to include a URN scheme identifier for identifying a URN scheme, a scheme-dependent part for identifying a resource, and a URN scheme modifier for determining a URL for accessing the identified resource;
means for detecting the URN scheme modifier in the received URI; and
means for determining, based on the detected URN scheme modifier, the URL for accessing the resource.

24. A computer readable medium embodying a computer program, executable by a machine, for accessing a resource based on URN scheme modifiers, the computer program including executable instructions for:
receiving a URI formatted to include a URN scheme identifier for identifying a URN scheme, a scheme-dependent part for identifying a resource, and a URN scheme modifier for determining a URL for accessing the identified resourcet;
detecting the URN scheme modifier in the received URI; and
determining, based on the detected URN scheme modifier, the URL for accessing the resource.

25. A method for providing a resource including a URI configured for accessing another resource, the method comprising:
receiving resource information for generating a first resource;
receiving a URN identifying a second resource;
determining a URI based on the URN, wherein the URI is formatted to include the URN, a URN scheme identifier for identifying a URN scheme, and a URN scheme modifier for modifying the processing of the URN according to the scheme, wherein the URN scheme modifier includes a resolving URL for determining a URL for accessing the second resource; and
generating the first resource based on the resource information and the determined URI, wherein the URI is configured to provide for a client receiving the generated first resource to determine based on the URN scheme modifier the URL for accessing the second resource.
